(19) United States
(12) Patent Application Publication
(10) Pub. No.: US 2026/0106465 A1
(43) Pub. Date: Apr. 16, 2026

(54) STANDALONE MOBILE DEVICE CHARGING AND SPEAKER DEVICE

(71) Applicant: Shelter Intelligence, Inc., Pasadena, CA (US)

(72) Inventor: Armen Gharabegian, Glendale, CA (US)

(21) Appl. No.: 19/356,918

(22) Filed: Oct. 13, 2025

Related U.S. Application Data
(60) Provisional application No. 63/706,693, filed on Oct. 13, 2024.

(51) Int. Cl. H02J 7/35; A47B 11/00; A47B 13/12; H02J 7/34; H02J 7/70; H02J 50/10; H02S 20/30; H02S 40/38; H04R 1/02

(52) U.S. Cl. CPC H02J 7/35; A47B 11/00; A47B 13/12; H02J 7/342; H02J 7/731; H02J 50/10; H02S 20/30; H02S 40/38; H04R 1/026; A47B 2220/0091; H02J 2207/10; H04R 2420/07

(57) ABSTRACT

A solar-powered table including a base unit and a top section detachably coupled or connected to the base unit. The top section includes one or more solar cell assemblies including one or more solar cells, the one or more solar cells to receive light from a solar light source and convert the light to electrical energy; one or more battery charge controllers coupled to the one or more solar cell assemblies and one or more rechargeable batteries to receive the electrical energy and to transfer the electrical energy to charge the one or more rechargeable batteries; and one or more processors or controllers.

### RELATED APPLICATIONS

This application claims priority and is a continuation of application Ser. No. 63/706,693, filed Oct. 13, 2024, the disclosure or which is incorporated entirely by reference.

### BACKGROUND

There are many places having charging speaker devices indoors. However, a need exists for providing charging for speaker devices and mobile communication devices in outdoor areas using solar power and then moving the speaker device indoors.

### BRIEF DESCRIPTION OF THE DRAWINGS

A better understanding of the features, advantages and principles of the present disclosure will be obtained by reference to the following detailed description that sets forth illustrative embodiments, and the accompanying drawings of which:

FIG. 1 illustrates a mobile communication device charging and protection stand or table according to some embodiments;

FIG. 2 illustrates a block diagram of a control housing 120 according to some embodiments;

FIG. 3A illustrates a side view of a shelf assembly 130 according to some embodiments;

FIG. 3B illustrates a block diagram of a table-top assembly according to some embodiments;

FIG. 4 illustrates a mobile communication device configured to engage in bidirectional communications with a charging and protection stand according to some embodiments;

FIG. 5A illustrates a side view of a mobile communication device charging and protection stand or table according to some embodiments;

FIG. 5B illustrates a front view of the mobile communication device charging and protection stand or table according to some embodiments;

FIG. 5C illustrates a perspective top view of the mobile communication device charging and protection stand or table according to some embodiments;

FIG. 5D illustrates a top view of the mobile communication device charging and protection stand or table according to some embodiments;

FIG. 6A illustrates a side view of a sun table power apparatus according to some embodiments;

FIG. 6B illustrates the components or portions of the sun table apparatus illustrated in FIG. 6A;

FIG. 7A illustrates a side view of a free-standing sun table power charging apparatus including a one-sided shelf assembly according to some embodiments;

FIG. 7B illustrates a front view of a free-standing sun table power charging apparatus including a one-sided shelf assembly according to some embodiments;

FIG. 7C illustrates a top view of a free-standing sun table power charging apparatus including a one-sided shelf assembly according to some embodiments;

FIG. 8A illustrates a front view of a sun table charging apparatus to be utilized in loose ground environments such as sand according to some embodiments;

FIG. 8B illustrates a side view of a sun table charging apparatus to be utilized in loose ground environments such as sand according to some embodiments;

FIG. 9A illustrates a parasol with an attachable or connectable solar shelf according to some embodiments;

FIG. 9B illustrates a top view of a solar shelf or sun table according to some embodiments;

FIG. 9C illustrates a cut away side view of the attachable or connectable solar shelf according to some embodiments; and

FIG. 9D illustrates a side view of a top section and a bottom section of the attachable or connectable solar shelf according to embodiments;

FIG. 10A illustrates a mobile phone charging stand and speaker in a charging configuration according to exemplary embodiments;

FIG. 10B illustrates removal of the mobile phone charging stand and speaker in order to port or move the mobile phone charging stand and/or speaker into a different environment (such as an indoor environment);

FIG. 10C illustrates a smaller version of a mobile phone charging stand and/or speaker that may be utilized in environments with smaller space constraints;

FIG. 10D illustrates a block diagram of a mobile device charging and speaker device including an automatic rotation assembly in accordance with embodiments;

FIG. 11A illustrates a movable or portable solar-power speaker assembly according to exemplary embodiments;

FIG. 11B illustrates a smaller base unit for use with the solar-powered speaker device 1100 according to exemplary embodiments;

FIG. 11C illustrates an exploded view of a base unit with the body of the solar-powered speaker device 1100 according to exemplary embodiments;

FIG. 12A illustrates a portable solar-powered table according to exemplary embodiments;

FIG. 12B illustrates an underside of a portable solar-powered table according to exemplary embodiments; and

FIG. 12C illustrates a side view of a portable solar-powered table according to exemplary embodiments.

### DETAILED DESCRIPTION

The following detailed description and provides a better understanding of the features and advantages of the inventions described in the present disclosure in accordance with the embodiments disclosed herein. Although the detailed description includes many specific embodiments, these are provided by way of example only and should not be construed as limiting the scope of the inventions disclosed herein. In the following detailed description, numerous specific details are set forth to provide a thorough understanding of claimed subject matter. For purposes of explanation, specific numbers, systems and/or configurations are set forth, for example. However, it should be apparent to one skilled in the relevant art having benefit of this disclosure that claimed subject matter may be practiced without specific details. In other instances, well-known features may be omitted and/or simplified so as not to obscure claimed subject matter. While certain features have been illustrated and/or described herein, many modifications, substitutions, changes and/or equivalents may occur to those skilled in the art. It is, therefore, to be understood that appended claims are intended to cover any and all modifications and/or changes as fall within claimed subject matter. References throughout this specification to one implementation, an implementation, one embodiment, embodiments, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term “coupled” is also understood generically to mean indirectly connected, for example, in an appropriate context. The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics.

Likewise, the term “based on,” “based, at least in part on,” and/or similar terms (e.g., based at least in part on) are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more illustrative examples; however, again, particular context of description and/or usage provides helpful guidance regarding inferences to be drawn

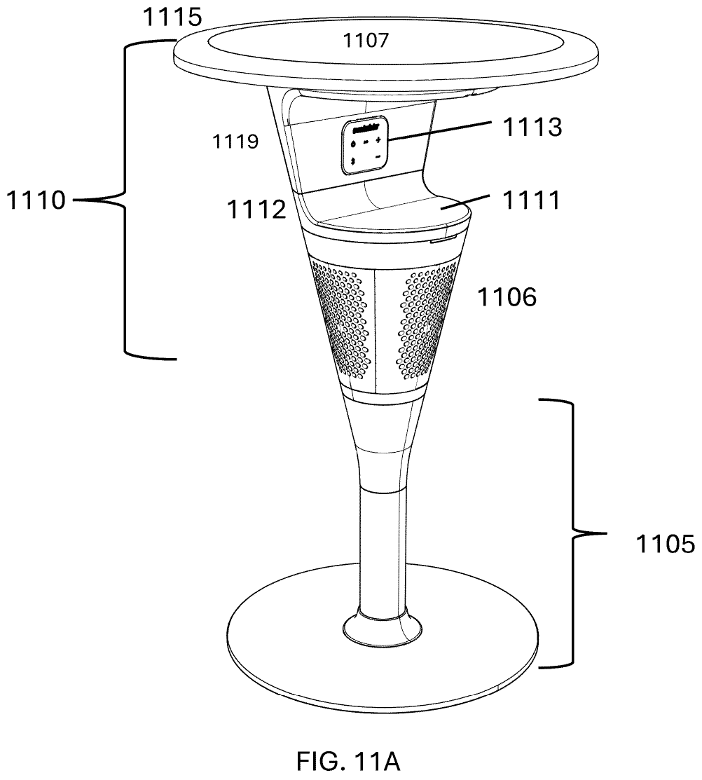

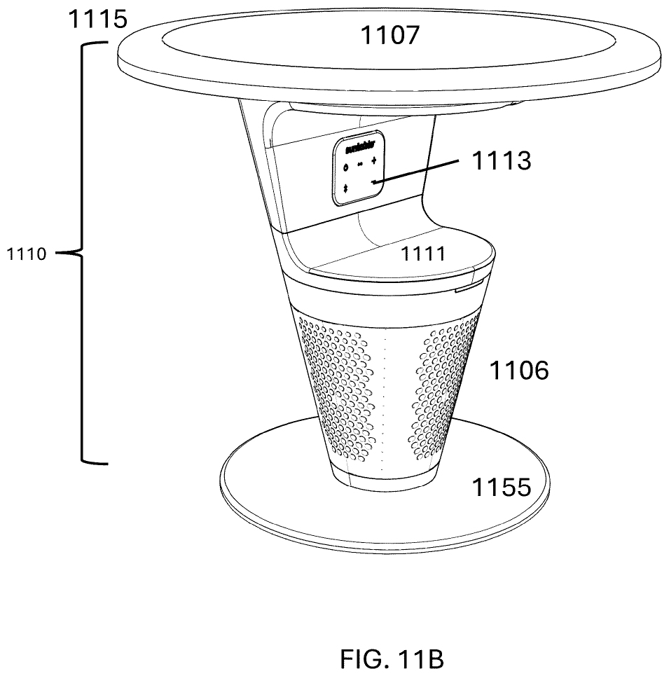

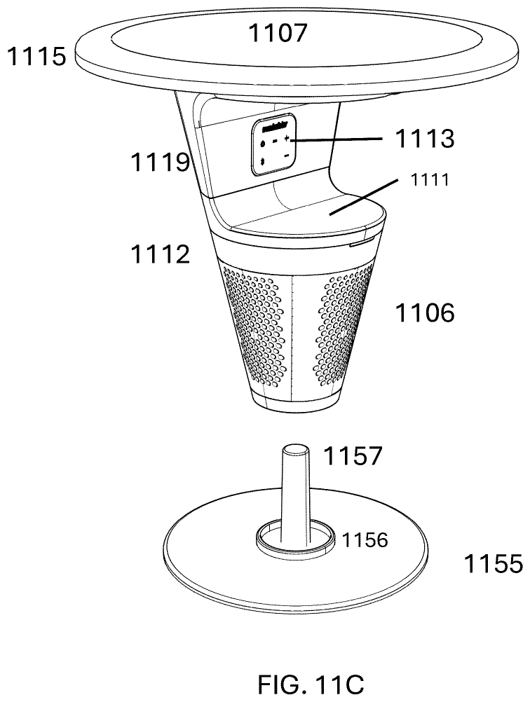

FIG. 11A illustrates a movable or portable solar-power speaker assembly according to exemplary embodiments. In exemplary embodiments, the portable solar-power speaker device may be charged and powered by one or more solar cells or assemblies integrated therein in an outdoor environment and then may be moved to an indoor or protected environment where music may be played by a mobile communication device that is communicatively coupled to the one or more speakers or speaker assemblies in the portable solar-power speaker assembly. This is a unique device in that most devices require USB power, direct cable power from another device or connection to an electrical outlet via cable in order to be charged, whereas the claimed subject matter and device may be utilized in environments that do not have readily available power such as outdoor concerts or events, camping sites or remote areas (which could have indoor structures but may not have power or may have limited power). In exemplary embodiments, the portable solar-powered speaker assembly 1100 may include a main body 1110 and a bottom or base unit 1105. In exemplary embodiments, the main body 1110 of the portable solar-power speaker assembly 1100 may be detachable and thus separatable from the base unit 1105 in order to allow the portability described above. In exemplary embodiments, the main body 1110 of the portable solar-power speaker assembly 1100 may include a shelf assembly or portion 1115, a vertical connection assembly or portion 1119, a horizontal resting assembly or portion 1112, and/or one or more speaker assemblies 1106. In exemplary embodiments, the horizontal resting area or portion 1112 may include an inductive charging assembly 1111. In exemplary embodiments, the vertical connection assembly or portion 1119 may include a control panel 1113 with one or more selection buttons or icons, as described above. In exemplary embodiments, the vertical connection assembly or portion 1119 may connect or couple the shelf assembly or portion 1115 to the horizontal resting area or shelf assembly 1112. In exemplary embodiments, the horizontal resting area or shelf 1112 may be connected and/or coupled to the one or more speakers 1106. In exemplary embodiments, the one or more speakers 1106 may reside below the horizontal resting area or shelf 1112.

A novel feature of the portable solar-power speaker device 1100 is its portability and detachability. In exemplary embodiments, the base assembly or unit 1105 may be detachable or separatable from the speaker device main body 1110. In outdoor environments, a base assembly or unit 1105 having a substantial height (e.g., ranging from 1 feet to 6 feet) may be preferrable in order for the table top or shelf assembly 1115 to be at a higher level and closer to the sun (which powers the solar cells or assemblies). In addition, having such a height in an outdoor environment may allow a minimization of other obstacles from preventing the sun or light source from being in the path between the sun or light source and the tabletop or shelf assembly 1115 which includes the solar cells or assemblies. FIG. 11B illustrates a smaller base unit for use with the solar-powered speaker device 1100 according to exemplary embodiments. In exemplary embodiments, the base unit 1155 illustrated in FIG. 11B would be ideal for indoor embodiments and would provide stability to the solar-power speaker device 1100. In exemplary embodiments, the base unit or assembly 1155 may be circular in shape and flat on its bottom surface and may be placed anywhere in an indoor environment. In other words, the solar-power speaker device 1100 may be placed outdoors where the batteries integrated therein may be charged by the solar cells and then be brought indoors where it may still operate as long as the batteries are charged. In other words, the solar-power speaker device 1100 may place music indoors.

In exemplary embodiments, a user may place their phone (or mobile communication device) on the inductive charging assembly 1111 in order to charge the mobile communication device) even if the solar-powered speaker device 1100 is located indoors. In these embodiments, the mobile communication device may also stream music files to the solar-powered speaker device 1100 and the one or more speakers or speaker assemblies 1106 may play the music or reproduce the music files as sound on the one or more speakers or speaker assemblies.

FIG. 11C illustrates an exploded view of a base unit with the body of the solar-powered speaker device 1100 according to exemplary embodiments. FIG. 11C illustrates how a main body 1110 of the solar-powered speaker device 1100 is connected to the base unit or base assembly 1155. As illustrated in FIG. 11C, the base unit or base assembly 1155 may have a circular ridge 1156 and a post 1157. In exemplary embodiments, the main body 1110 may have reciprocal or aligned assemblies to connect with the base unit or base assembly 1155. As examples, the main body 1110 may have a circular channel (not shown) opposite the circular ridge 1156 which aligns with and allows the circular ridge to fit into the circular channel of the main body. Similarly, the main body 1110 may have a hole or cylindrical opening (not shown) opposite the cylindrical post 1157 of the base unit 1105. This allows additional alignment and connection with the main body 1110 and assists in preventing the main body 1110 from moving or falling over when connected or coupled to the base unit or assembly 1110 of the solar powered speaker device.

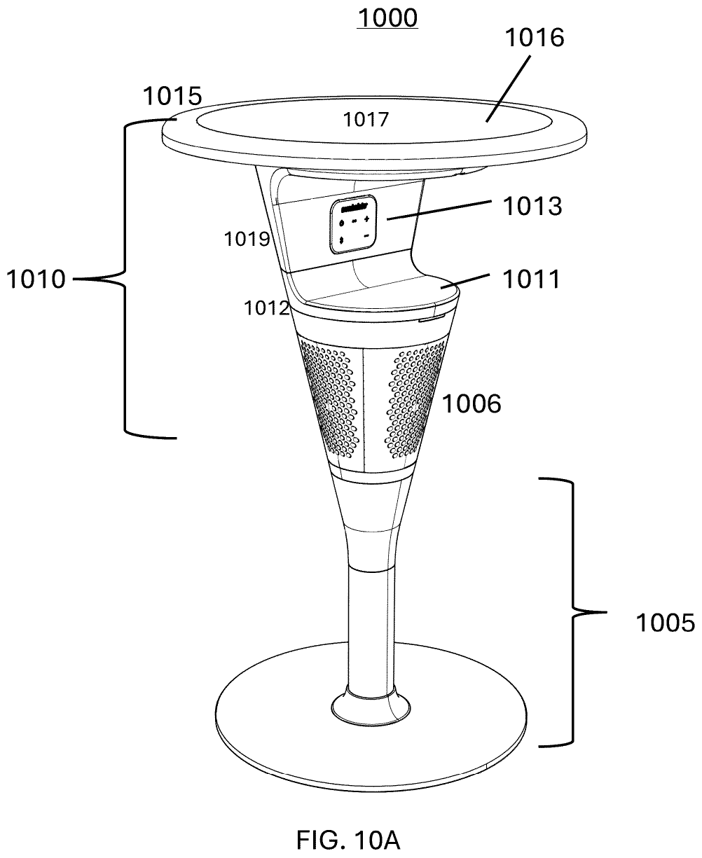

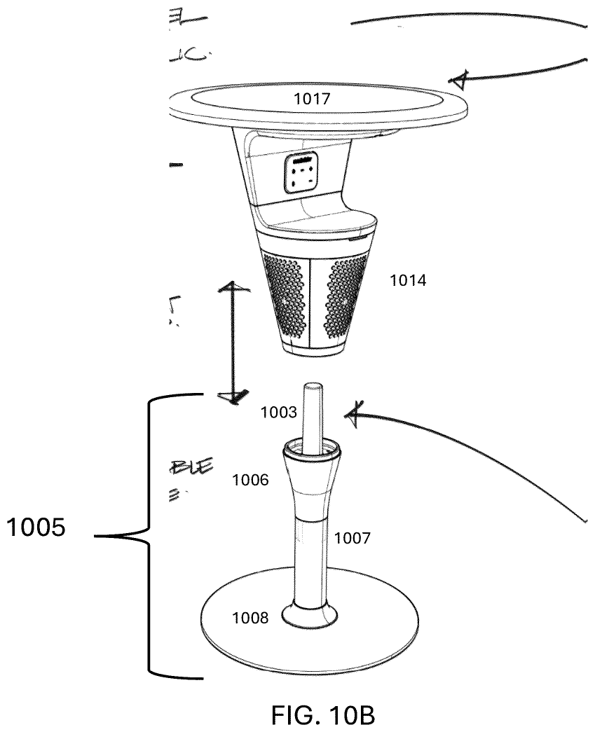

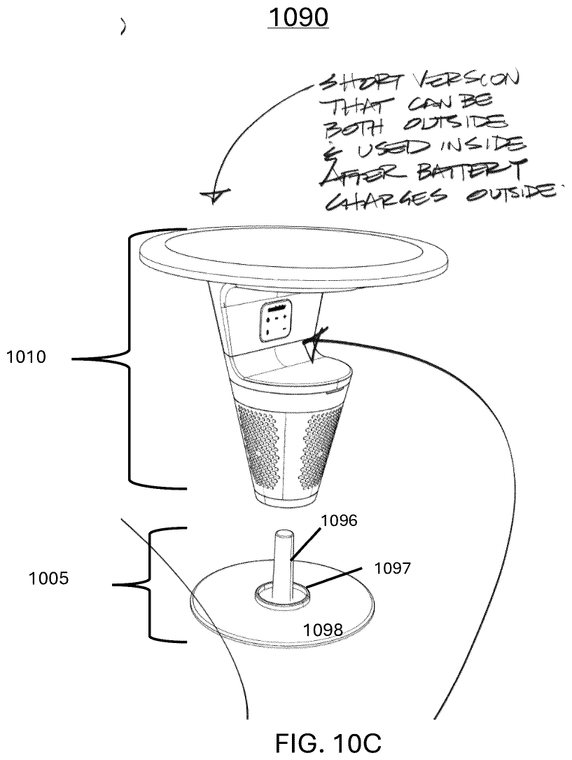

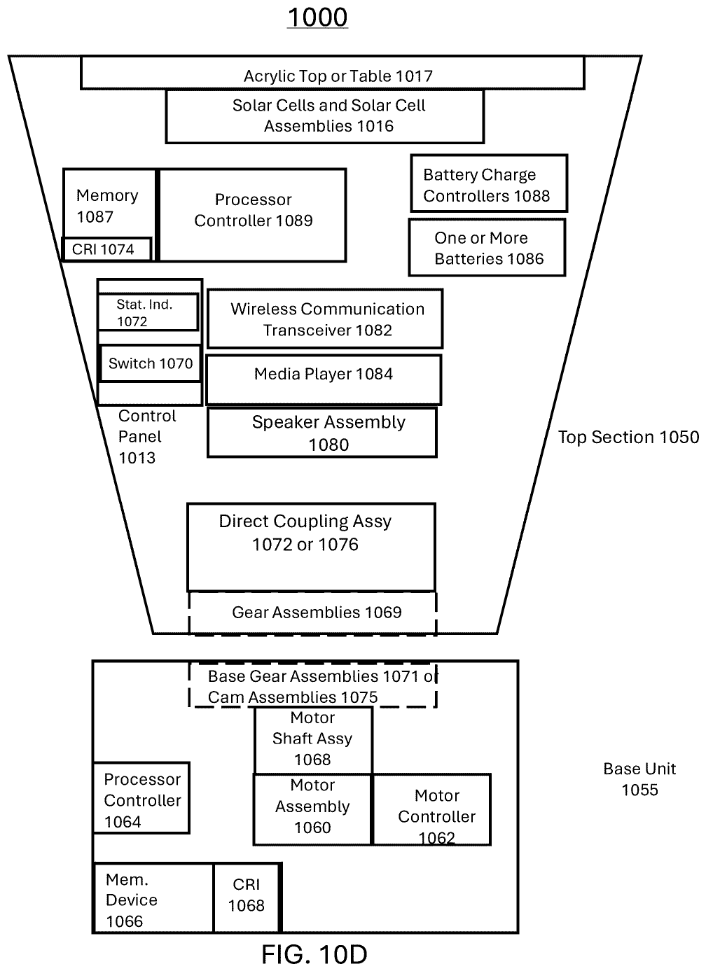

FIG. 10A illustrates a mobile phone charging stand and speaker device in a charging configuration according to exemplary embodiments. The uniqueness of this device is that the top portion or main body is detachable and can be moved from outdoors to indoors, it is compact and free-standing and can be utilized as a table, it can play music and it also protects a mobile device from sunlight and/or heat when it is charging. FIG. 10B illustrates removal of the mobile phone charging stand and speaker (the upper portion or main body) in order to port or move the mobile phone charging stand and/or speaker into a different environment (such as an indoor environment). FIG. 10C illustrates a smaller version of a mobile phone charging stand and/or speaker that may be utilized in environments with smaller space constraints. In FIG. 10A, a mobile communications device charging and speaker device 1000 may include a top section or main body 1010 and/or a base assembly or base unit 1005. In exemplary embodiments, a top section or main body 1010 may include a tabletop 1015, a control panel 1013, a mobile device resting area 1012, an inductive charger or charging assembly 1011, and/or one or more speaker assemblies 1014. In exemplary embodiments, the tabletop 1015 may be a horizontal and flat surface. In exemplary embodiments, the tabletop 1015 may include a clear, acrylic and/or or transparent surface covering a majority of its area (e.g., 60 to 80 percent of surface area of the table top). In exemplary embodiments, the clear or transparent surface 1017 may be an acrylic surface which is transparent, but also strong enough to protect one or more solar cells or solar cell assemblies 1016 which are positioned beneath the clear or transparent surface 1017. In exemplary embodiments, the one or more solar cells or solar cell assemblies 1016 may be positioned under the sun and may capture sunlight and convert the sunlight into electrical energy, which may charge batteries inside the mobile device charging and speaker device 1000. Accordingly, the one or more solar cells or solar cell assemblies 1016 may cover a surface area that is similar but slightly smaller than the clear, acrylic or transparent surface 1017 in order to maximize an amount of electrical energy or power that may be generated (e.g., covering an area from 60 to 95 percent of the clear or transparent surface 1017). In exemplary embodiments, the one or more solar cells or solar cell assemblies 1016 may be mounted on a surface of the tabletop assembly 1015. In exemplary embodiments, the one or more solar cells or solar cell assemblies 1016 may be integrated into a tabletop 1015 of the mobile device charging and speaker device 1000. In exemplary embodiments, a neck 1019 of the main body 1010 may connect a tabletop assembly 1015 to a mobile device resting area 1012. In exemplary embodiments, the neck 1019 may be a vertical surface on one side of a mobile communications device charging and speaker device 1000 (in FIG. 10A, it is on a left side). In exemplary embodiments, the neck or neck assembly 1019 may include a control panel 1013 which may allow operation of the mobile communications device charging and speaker device 1000. In exemplary embodiments, the control panel 1013 may include status indicators, a power on and/or off switch, a rotation switch, and/or may include a charging port (for charging a mobile communication device via a cable). In exemplary embodiments, the mobile device resting area 1012 of the main body 1010 may be a horizontal and/or flat surface. In exemplary embodiments, one or more inductive charging assemblies 1011 may be embedded in, integrated within, or positioned on the mobile device resting area 1012. In exemplary embodiments, after the mobile communication device charging and speaker device 1000 converts the solar energy or sunlight to electrical energy and charges an internal power source (e.g., a battery and/or a battery charging controller), the one or more inductive charging assemblies 1011 may charge a mobile communication device placed on it's surface. In exemplary embodiments, a speaker assembly 1014 may be positioned underneath the mobile device resting area 1012. In exemplary embodiments, the speaker assembly 1014 may be circular and may cover 360 degrees around the mobile communications device charging and speaker device 1000. In exemplary embodiments, the one or more speaker assemblies 1014 may be detachable to allow for different upgrades or replacement. This allows for individuals to be able to hear the music from any place in an outdoor or indoor environment.

In exemplary embodiments, the mobile device charging and speaker device 1000 may include a base assembly or base unit 1005. In exemplary embodiments, the base unit or base assembly 1005 may be connected an/or coupled to the main body 1010. In exemplary embodiments, the base unit or base assembly 1005 may be positioned under the main body 1010 and a top portion 1006 of the base unit or base assembly 1005 may be connected or coupled to main body 1010 and specifically underneath the one or more speaker assemblies 1014. In exemplary embodiments, the base unit or base assembly 1005 may be configured to provide stability for main body 1010 and to allow the mobile device charging and speaker device 1000 to be placed on a ground surface or a horizontal surface. As illustrated in FIG. 10B, in exemplary embodiments, the base unit or base assembly 1005 may include a top portion or section 1006 (couple or connected), a middle section 1007 and a stand 1008. In exemplary embodiments, the top portion or section 1006 may be vertically disposed cylinder that has a slightly reducing width, the middle section 1007 may be connected to the top portion or section 1006 and may be a cylindrical in shape, and the stand 1008 may be horizontally disposed and have a larger diameter than the top portion or section 1006 in order to provide stability for the main body 1010 of the mobile device charge and speaker device 1005. In exemplary embodiments, the middle section 1007 may be coupled and/or connected to the stand 1008.

FIG. 10B illustrates removable of a detachable main body or top section of a mobile device charging and speaker device in accordance with embodiments. In exemplary embodiments, the top portion or section 1006 of the base assembly or base unit may include a cylindrical pole 1003 disposed vertically that sticks about above a top surface of the top portion or section 1006 of the base unit 1005. In opposition to the cylindrical pole or post 1003, the main body 1010 may have a receiving area or spacing in a center to receive the cylindrical pole 1003. In exemplary embodiments, the cylindrical pole 1003 may be press-fit into the upper portion or main body receiving area or spacing to provide stability. In exemplary embodiments, the receiving area or spacing may be cylindrical in shape and may mate with the cylindrical pole or post 1003. It also may be located in a middle of the one or more speaker assemblies 1014 (such a circular area running throughout the one or more speaker assemblies 1014). In exemplary embodiments, the press-fitting may allow a mobile device charging and speaker device user to rotate a top section or main body 1010 clockwise or counter-clockwise with respect to the base unit or base assembly 1005. By rotating the top section or main body 1010, a mobile device that is placed or positioned on the rest area 1012 may be protected from overheating due to direct exposure to sunlight. This is a unique and novel feature of the mobile device charging and speaker assembly that has a utility of protecting a mobile communication or computing device from overheating. In some implementations, the rest area 1012 that includes the integrated inductive charging assembly 1011 may be referred to as a charging area. In addition, by keeping sunlight off the charging area, the integrated inductive charging assembly 1011 may also be protected from overheating.

FIG. 10D illustrates a block diagram of a mobile device charging and speaker device including an automatic rotation assembly in accordance with embodiments. FIG. 10B's rotation of the top section 1010 with respect to the bottom or base unit 1005 is manually done. Rather than requiring a user to manually rotate the main body or top section 1050 with respect to the base unit or base assembly 1055, the mobile device charging and speaker device 1000 may include an automatic rotation assembly. In exemplary embodiments, the mobile device charging and speaker device 1000 may include a main body or top section 1050 and/or a base unit 1055. Although the discussion below and FIG. 10D may identify that the motor assembly and components are in the base unit 1055, the motor assembly and components may also be in the main body and/or top section 1050. In many embodiments, the motor assembly and components may be in the base unit 1055 so that the main body or top section 1050 may not weigh as much, since it is detachable and can be moved to a different environment after the main body or top section 1050 has been charged. In exemplary embodiments, the base unit 1055 may include one or more motor assemblies 1060, one or more motor controllers 1062, one or more controllers or processors 1064, one or more memory devices 1066, and/or one or more motor shaft assemblies 1068. In some implementations, the rotation may be activated by one or more switching assemblies 1070. In exemplary embodiments, the one or more switching assemblies 1070 may be located in the top section 1050 and/or the base unit 1055 (although FIG. 10D illustrates the one or more switching assemblies 1070 in the top section 1050. In other implementations, the rotation of the top section or main body 1050 with respect to the base unit 1055 may be activated by a mobile software application that interfaces with the mobile device charging and speaker device 1000. In other implementations, the rotation may be activated automatically depending upon an orientation or positioning of the rest area 1012 and inductive charging assembly 1011 with respect to sunlight and/or a temperature of the rest area 1012 and inductive charging assembly 1011 (where a light sensor or a temperate sensor in the rest area 1012 may generate light measurements or temperature measurements and if the light measurements or the temperature measurements are over a specified threshold), a controller or processor 1089 may generate a signal to the one or more motor controllers 1062 to initiate the one or more motor assemblies 1060 to rotate the top section or main body 1050 with respect to the base unit 1055. In exemplary embodiments, in response to a light measurement or a temperature measurement being too high or over a specific threshold, computer-readable instructions 1074 may be executable by the one or more processors or controllers 1089 to generate and/or communicate a signal to the one or more motor controllers 1062 in order to rotate the top section or main body 1050 with respect the base unit 1055. In other embodiments, computer-readable instructions 1074 stored in the one or more memory devices 1087 may be executable by the one or more processors or controllers 1089 to control other operations of the mobile device charging and speaker device 1000. In other embodiments, computer-readable instructions 1068 may be stored in one or more memory devices 1066 of the base unit 1055 and may be executable by the one or more processors or controllers 1064 in the base unit 1055 to control operations of the mobile device charging and speaker device 1000.

In exemplary embodiments, the control panel 1013 may include one or more switching assemblies 1070. In exemplary embodiments, the one or more switching assemblies 1070 (when pressed or activated) in the main body 1050 may communicate a signal to the one or more motor controllers 1062. In exemplary embodiments, the one or more motor controllers 1062 may communicate with the one or more motor assemblies 1060 to initiate operation which results in rotation of the motor shaft assemblies 1068. In exemplary embodiments, the main body or upper section 1050 may include a direct coupling assembly 1072 (which may be an axle or a spindle). In these embodiments, the one or more motor shaft assemblies 1068 in the base unit 1055 may be coupled to the direct coupling assembly 1072 and this may allow rotation of the main body or upper portion 1050 with respect to the base unit 1055.

In exemplary embodiments, instead of a direct coupling assembly, the main body or upper portion 1050 may also include one or more gearing assemblies 1069 and the base unit or base assembly 1055 may include one or more base gearing assemblies 1071. In exemplary embodiments, the one or more base gearing assemblies 1071 may be coupled and/or connected to the motor shaft assemblies 1068 and the one or more gearing assemblies 1069 in the main body may be attached to an axle or spindle assembly in the main body 1050. In exemplary embodiments, when the one or more motor shaft assemblies 1068 are rotated, the one or more base gearing assemblies 1071 may mesh with the one or more gearing assemblies 1069 in the top section or main body 1050 and may transfer rotational motion from the motor shaft 1068 to the main body's rotating component. Gears mesh together to transfer rotational motion from the base unit motor shaft assemblies 1068 to the top section or main body 1050. In exemplary embodiments, one or more cam assemblies 1075 may be utilized to transfer rotational motion from the base unit motor shaft assemblies 1068 to the top section or main body 1055 (rather than gearing assemblies 1072). In these embodiments, the base unit 1055 may include one or more cam assemblies 1075. The one or more cam assemblies 1075 may be attached to the one or more motor shaft assemblies 1069 and may interface or interact with an axle or spindle 1076 in the main body or top section 1050 and may cause rotation of the top section or main body 1050 with respect to the base assembly or base unit 1055. In exemplary embodiments, the one or more motor assemblies 1060 may be stepper motor or servo motor in order to provide fine and accurate movements.

In exemplary embodiments, returning to FIGS. 10A and 10B, the top section or main body 1010 being detachable from the base unit or base assembly 1005 allows a user to charge up the top section or main body 1010 and then move the top section or main body 1010 into a different environment (that is not subject to heat and/or sunlight). More specifically, the top section or main body 1010 includes one or more speakers assemblies 1080 or 10114 and thus the top section or main body 1010 may play music in the different embodiments. In addition, the integrated inductive assembly 1011 may also charge one or more mobile communication or computing devices while playing music. Further, in addition, the top section or main body 1010 may also be used as a table due to the smooth acrylic top 1017 while playing music and charging mobile communication devices. There are no portable and standalone devices in the market that have all of these capabilities.

In exemplary embodiments, the one or more speaker assemblies 1080 may play or reproduce music transferred to it by a music or media player 1084. In exemplary embodiments, the music files to be played may be stored in the one or more memory devices 1087. In these embodiments, computer-readable instructions 1074 stored in the one or more memory devices 1087 may be executable by the one or more processors or controllers 1089 and may access the music files from the one or more memory devices 1087 and may transfer the music files to the media player 1084. In these embodiments, the media player 1084 may and then play or reproduce the music files utilizing the one or more speaker assemblies 1080. In exemplary embodiments, a mobile computing device or phone may communicate the music files with the mobile device charging and speaker device 1000 via a personal area network (PAN) wireless transceiver (e.g., a Bluetooth transceiver). In these embodiments, the mobile communication device may communicate the music files to the mobile device charging and speaker device 1000 and a PAN wireless transceiver 1082 may receive the music files, transfer the music files to the media player 1084, which in turn may reproduce the music files on the one or more speaker assemblies 1080. In other embodiments, the mobile communication device may communicate the music files to the mobile device charging and speaker device 1000 via a WiFi communication transceiver. In these embodiments, the mobile communication device may communicate the music files to the mobile device charging and speaker device 1000 and the WiFi 802.11 wireless transceiver 1082 may receive the music files to the media player 1084, which in turn may reproduce the music files on the one or more speaker assemblies 1080. In another embodiments, the mobile communication device may communicate the music files to the mobile device charging and speaker device 1000 via a near-field communication wireless transceiver. In these embodiments, the mobile communication device may communicate the music files to the mobile device charging and speaker device 1000 by touching or tapping the NFC communication transceiver 1082. In these embodiments, the NFC communication transceiver 1082 may receive the music files to the media player 1084, which in turn may play or reproduce the music files on the one or more speaker assemblies 1080.

FIG. 10C illustrates a shorter version of the mobile device charging and speaker assembly in accordance with embodiments. In exemplary embodiments, the main body or top section 1010 may be the same as the embodiments illustrated in FIGS. 10A and 10B. In this embodiments, the base unit 1095 may include a mounting post 1096, a seating ridge 1097 and/or a circular or oval base place 1098. In exemplary embodiments, the main body or top section 1010 may include a circular receiving area for the seating area 1097 in order to allow the main body or top section 1010 to be stabilized on the base unit 1095.

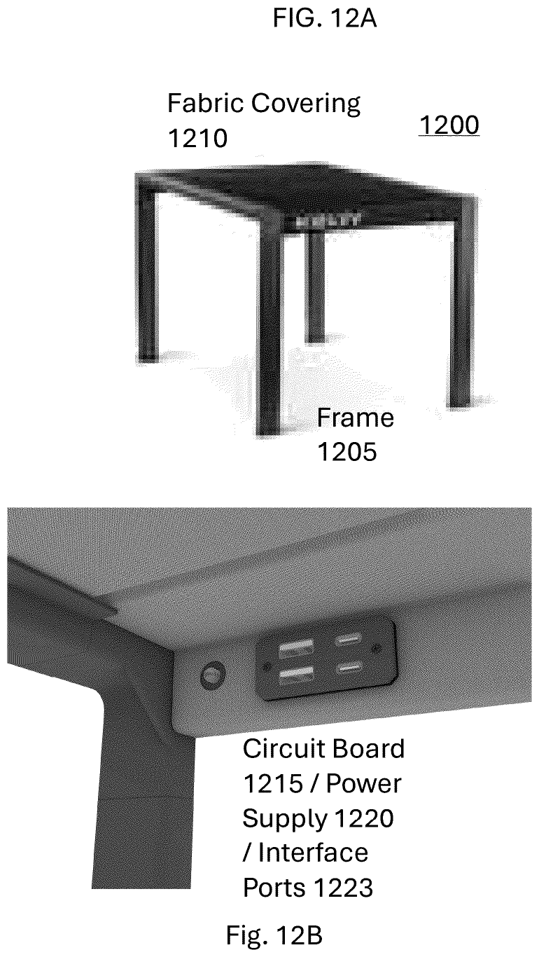

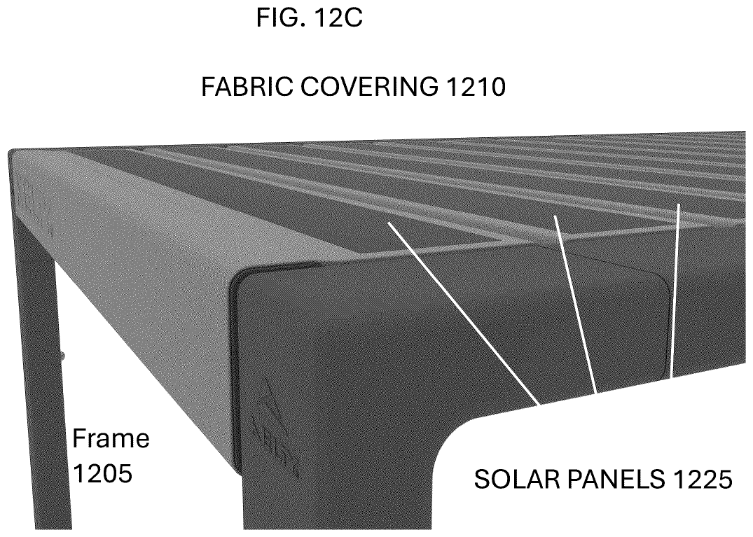

FIG. 12A illustrates a portable solar-powered table and charging assembly according to exemplary embodiments. FIG. 12B illustrates an underside of a portable solar-powered table and charging assembly according to exemplary embodiments. FIG. 12C illustrates a side view of a portable solar-powered table and charging assembly according to exemplary embodiments. FIG. 12A illustrates a portable solar-generated table and charging assembly 1200 including a frame 1205 and a fabric covering 1210 that is stretched over the frame or table frame 1210. In exemplary embodiments, the fabric covering 1210 covers a top portion of the frame or table frame 1205. In exemplary embodiments, the frame or table frame 1205 may be multiple pieces that are attached to each other to form the table frame. These pieces may be flat or small in nature in order to be carried with a hiker or camper a distance from the car. In addition, the fabric covering 1210 may be rolled up into a circle or an oval around a center axis in order for the fabric covering to form a circular or oval roll which is also easily put into a storage or carrying bag along with the detached or unattached sections or pieces of the table frame. In exemplary embodiments, the fabric in the fabric covering may be a canvas or a thick material (which can be rolled) but also provides sturdiness and/or strength. FIG. 12B illustrates one or more circuit boards 1215, one or more power supplies or one or more rechargeable batteries 1220 and/or one or more interface ports 1223 that are utilized in the portable solar-powered table and charging assembly 1200. In exemplary embodiments, the one or more circuit boards 1215, the one or more rechargeable batteries 1220 and the one or more interface ports 1223 may be in one physical enclosure which is attached to an inside portion of the table frame 1205. In exemplary embodiments, the fabric covering 1210 may include one or more solar assemblies or panels 1225, each of the one or more solar assemblies or panels 1225 including one or more solar cells. In exemplary embodiments, the one or more solar assemblies or panels 1225 may be inserted into pockets of the fabric covering 1210 or may be integrated into the fabric covering. In exemplary embodiments, the one or more solar assemblies or panels 1225 with the fabric covering 1210 may provide a stable support in order to be a tabletop where items may be placed. In exemplary embodiments, there may be between five and twenty solar assemblies or panels 1225 integrated into or placed into the pockets in the fabric covering 1210. In exemplary embodiments, the one or more solar assemblies or panels 1225 may be connected and/or coupled to each other to generate additional power. In exemplary embodiments, the one or more solar assemblies or panels 1225 are facing the sun or a solar light source and may convert the light rays from the sun or the solar light source into electrical energy. In exemplary embodiments, the one or more solar assemblies or panels 1225 may transfer the electrical energy to the one or more power supplies or rechargeable batteries 1220 and/or battery chargers or controllers (not shown). In exemplary embodiments, the one or more power supplies or rechargeable batteries 1220 and/or battery controllers may provide electrical power to the circuit board 1215. In exemplary embodiments, the one or more circuit boards 1215 may convert the electrical power from the one or more power supplies or rechargeable batteries 1220 into voltages that are compatible with mobile or portable computing devices. In other words, the one or more circuit boards 1215 may include voltage converters. In exemplary embodiments, the one or more circuit boards 1215 may transfer the voltages to the one or more interface ports 1223. In exemplary embodiments, the interface ports 1223 may be USB-C, USB-A or USB-B interface ports or other voltage ports. In exemplary embodiments, the one or more circuit boards 1215, the one or more power supplies or rechargeable batteries 1220 and/or the one or mor interface ports 1223 may be installed on an underside of the portable solar-powered table and charging assembly. In exemplary embodiments, the one or more circuit boards 1215, the one or more power supplies or rechargeable batteries 1220 and/or the interface ports 1223 may be installed on an underside of the frame 1205 of the portable solar-powered table.

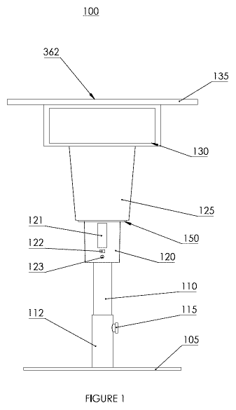

FIG. 1 illustrates a mobile communication device charging and protection stand or table according to some embodiments. In some embodiments, the mobile charging and protecting stand or table 100 may comprise a base or base assembly 105, an adjustable support assembly or center support assembly 110, an adjustment assembly 115, an control or electronics housing 120, a speaker or sound housing 125, a shelf assembly 130 and/or a tabletop assembly or table assembly 135. In some embodiments, the charging and protecting stand 100 may have an adjustable height. In some embodiments, the charging and protecting stand may range in 15 inches to 40 inches in height. In some embodiments, the base 105 and the tabletop assembly 135 may have a width of 20 inches to 40 inches. In embodiments, the tabletop assembly 135 may be referred to as the table assembly 135.

In some embodiments, an operator may utilize an adjustment assembly 115 (e.g., a knob, a switch, or other similar device) to adjust a height of the charging and protecting stand or table 100. In some embodiments, the base assembly 105 may have a top portion that is hollow or open and thus a portion of the length of the adjustable support assembly 110 may rest or be positioned within the top portion of base assembly 105 depending on the adjusted height. In some embodiments, the base assembly 105 may be circular in shape although other shapes may be utilized. In some embodiments, the top portion of the base assembly 105 may be circular and may include an opening or hollow space into which the adjustable support assembly 110 may be positioned and/or inserted. In some embodiments, the base assembly 105 may be made of a heavy material in order to provide stability to the charging and protecting stand or table 100. In come embodiments, the adjustable support assembly may be coupled, connected and/or attached to the base assembly 105 and/or the control housing 120. In some embodiments, the adjustable support assembly 110 may be a tube and/or a shaft. In some embodiments, the adjustable support assembly 110 may be a metal, a plastic, a combination of both and/or a composite material. In some embodiments, the adjustable support assembly 110 may be a housing and/or a tube or shaft. In some embodiments, the adjustable support assembly 110 may have a circular shape. In some embodiments, there may be no adjustable support assembly and the base assembly may comprise a circular flat portion and a small diameter tube assembly 112 that rises from the circular flat portion.

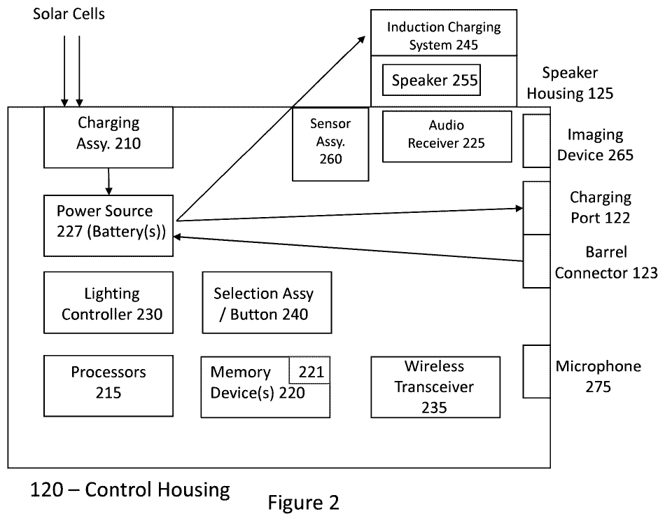

In some embodiments, the control housing 120 may comprise a plurality of buttons or selection assemblies 121, an universal serial bus (USB) or mobile communication device charger 122 to provide power and/or charging for mobile communication devices, and/or a barrel charging assembly port 123 to receive power from an external source such as a wall outlet and/or a generator. FIG. 2 illustrates a block diagram of a control housing 120 according to some embodiments. In some embodiments, the control housing 120 may comprise a charging assembly 210, one or more processors 215, one or more memory devices 220, and/or computer-readable instructions 221 stored in the one or more memory devices 220 and/or executable by the one or more one or more processors 215 to perform control housing and mobile phone charging and protection table or stand operations. In some embodiments, the control housing 120 may comprise one or more audio receivers 225 and/or one or more wireless communication transceivers 235. In some embodiments, the control housing 120 may comprise one or more microphones 275, one or more imaging devices 265, and one or more sensor assemblies 260. In some embodiments, the control housing 120 may comprise one or more lighting controllers 230, a plurality of selection assemblies (e.g., manual buttons) 240 and/or one or more induction control circuit assemblies 245. While FIG. 2 illustrates that these components and/or assemblies may be located in the control housing 120, some of the components may be located in other assemblies (e.g., the speaker housing 125, the shelf assembly 130 and/or the tabletop assembly 135 (or even the base assembly 105). The specification should not be read to limit the locations of these components and assemblies to only the control housing although one embodiment may clearly include all the shown components and assemblies in the control housing 120. In some embodiments, as an example, the one or more audio receivers 225 may be located in the speaker housing 125 and not in the control housing 120.

In some embodiments, the one or more solar panels or solar cell assemblies may be coupled and/or connected to the one or more charging assemblies 210 and/or the one or more charging assemblies may supply power (e.g., voltage and/or current) to a rechargeable power source 227 (e.g., one or more rechargeable batteries). In some embodiments, the rechargeable power source 227 may provide power to other assemblies and/or components of the control housing 120 and/or the rest of the mobile device charging and protection table or stand 100. In some embodiments, the rechargeable power source 227 may provide power to a universal serial bus (USB) port or interface 122 in order to allow users and/or operators to charge mobile phones (mobile communication devices) or tablets by connecting a cable or adapter to the USB port/interface 122. In some embodiments, the rechargeable power source 227 may receive power not only from the solar panel or cells, but also may receive power from an external power source (e.g., generator or AC outlet) via a barrel connector 123.

In some embodiments, the control housing 120 may comprise a plurality of selection assemblies or buttons 121 that are on an outside surface of the control housing 120. In some embodiments, a plurality of selection assemblies or buttons 121 may comprise an on/off button, a wireless communication activation button, a lighting assembly activation button, a solar panel activation button, a voice command activation button (e.g., voice recognition) and/or an audio system activation button. In some embodiments, the selection assemblies or buttons 121 may interface with the associated and/or corresponding assembly or component, either directly and/or indirectly through the computer-readable instructions executable by the one or more processors. In some embodiments, the selection assemblies or buttons 121 may also alone, or in combination, be utilized to establish a password process, to initiate and/or execute a shutdown process, and/or to be utilized to establish customized settings for the one or more lighting assemblies 150 and/or speaker assemblies 255. In some embodiments, the control housing 120 may comprise one or more lighting assemblies 150 to shine or project light to an area around the mobile communication device charging and protection stand or table 100.

In some embodiments, the control housing 120 or the speaker housing 125 may comprise one or more lighting controllers 230 and/or one or more lighting assemblies 150. In some embodiments, computer-readable instructions executable by the one or more processors 215 may communicate with the one or more lighting controllers 230 to interface with the one or more lighting assemblies 150. In some embodiments, the computer-readable instructions executable by the one or more processors may communicate the following parameters and/or information through the one or more lighting controllers 230 to the one or more lighting elements and/or assemblies: 1) activation and/or deactivation times of the one or more lighting elements or assemblies 150; 2) intensity of the one or more lighting elements or assemblies 150; 3) patterns and/or sequencing of the one or more lighting elements or assemblies 150; and/or 4) colors projected of the one or more lighting elements or assemblies 150. In some embodiments, if the control housing 120 includes the one or more lighting assemblies 150 on a side outside surface of the control housing, the lighting assemblies may project light outwards from the control housing 120 and light up the environment around the mobile communication device charging and protection stand or table 100 according to some embodiments. In some embodiments, the one or more lighting element or assemblies 150 may be positioned or located on a bottom surface or portion of the speaker assembly 125 and thus may be directing light or light rays in a slightly downward direction and sideways direction from the speaker assembly 125.

In some embodiments, the control housing 120 or the speaker assembly 125 may comprise one or more wireless communication transceivers 235. In some embodiments, the one or more wireless communication transceivers 235 may be a low-energy personal area network (PAN) transceiver (e.g., a BLE transceiver or similar transceivers), a PAN transceiver (e.g., a Bluetooth or Zigbee transceiver), a wireless LAN, WiFi or IEEE 802.11 compatible wireless communication transceiver, and/or a cellular wireless communication transceiver (e.g., a 3G, 4G, or 5G cellular transceiver). In some embodiments, the one or more wireless communication transceivers 235 may receive operational commands from a mobile communication device and/or other computing devices via the one or more wireless communication transceivers 235. For example, these operational commands may be 1) turning on or off the lighting assemblies 230; 2) turning on or off the audio amplifier and/or speakers 225; 3) playing audio files via the one or more speaker assemblies 125; 4) turn on or off the one or more inductive charging assemblies 245; and/or 5) turning on or off the one or more charging assemblies 210 and/or the one or more solar panels. In some embodiments, the operational commands may be for other components and/or assemblies.

In some embodiments, the control housing 120 or the speaker housing 125 may comprise one or more audio receivers or amplifiers 225. In some embodiments, computer-readable instructions 221 executable by the one or more processors 215 of the mobile communication device charging and protection stand or table 100 may retrieve music and/or sound files from the one or more memory devices 220 and communicate the music and/or sound files to the one or more audio receivers or amplifiers 225 and then to one or more speaker assemblies 255. In some embodiments, the one or more speaker housings 125 may comprise one or more speaker assemblies 255 to reproduce and/or play transferred music and/or sound files. In some embodiments, there may be one or more speaker housings 125 or there may be one speaker housing 125. For simplicity, the specification may refer to one speaker housing 125. In some embodiments, the speaker housing 125 may further comprise one or more sound radiators, one or more amplifiers, and/or one or more subwoofers in order to enhance certain aspects of the reproduction and/or playing of the music and/or sound files. In some embodiments, rather than internally storing the music and/or sound files in the one or memory devices of the mobile communication device charging and protection stand or table 100, one or more wireless communication transceivers 235 may receive the music and/or sound files and may transfer the sound or music files to the one or more audio receivers or amplifiers 225. In some embodiments, a mobile communication device (e.g., a smartphone and/or tablet or a wearable computing device or other computing devices) may transfer the music and/or sound files to the one or more wireless communication transceivers 235 of the charging and protection stand or table 100. In some embodiments, the one or more wireless communication transceivers 235 may be a Bluetooth Low Energy (BLE) wireless communication transceiver in order to utilize less power. In other embodiments, the one or more wireless communication transceivers 235 may be a personal area network (PAN) transceiver (e.g., a Bluetooth transceiver), a WiFi or 802.11 wireless transceiver and/or a cellular communications transceiver (e.g., 3G, 4G or 5G). In some embodiments, streaming services (e.g., remote server computing devices and/or cloud-based server computing devices) may communicate the music and/or sound files to the mobile communication device charging and protection stand 100 via the one or more wireless communication transceivers 235. In some embodiments, transfer of music and/or sound files from a remote server computing device and/or cloud-based server may require a more robust and/or higher bandwidth communication channel and thus may utilize one or more wireless LAN, Wi or 802.11 wireless communication transceivers and/or cellular communication transceivers.

In some embodiments, the control housing 120, the speaker housing 125, the shelf assembly 130 and/or the table-top assembly may comprise one or more sensor assemblies 260. In some embodiments, the sensor assemblies 260 may comprise environmental sensor assemblies, directional sensor assemblies, and/or proximity sensor assemblies. In some embodiments, the environmental sensor assemblies may be wind sensor assemblies, humidity sensor assemblies, temperature sensor assemblies, ultraviolet UVa and UVB sensor assemblies, light sensor assemblies, air quality sensors (e.g., smoke sensors, methane sensors, carbon dioxide sensors, smog sensor assemblies, particulate matter sensor assemblies, volatile organize compounds (VOC) density sensor assembles, dust sensor assemblies) and/or lightning sensor assemblies. In some embodiments, the one or more sensor assemblies 260 in the mobile communication device charging and protection stand or table may be able to capture measurements and/or parameters of the environment around the charging and protection stand or table 100. In some embodiments, computer-readable instructions 221 executable by the one or more processors 215 may store the captured measurements and/or parameters (in one or more memory devices 220) of the one or more sensor assemblies 260 and/or communicate the captured measurements and/or parameters to an external computing device (e.g., like a mobile communication device) via one or more wireless communication transceivers 235. In some embodiments, the one or more sensor assemblies 260 may be proximity sensors. In some embodiments, the one or more proximity sensors may be motion detectors, line of sight detectors, proximity detectors or other detectors or sensors identifying whether movement is occurring around the mobile communication device charging and protection stand or table 100. In some embodiments, computer-readable instructions executable by the one or more processors 215 in the charging and protection stand or table may receive a signal, command and/or message from one or more proximity sensors identifying that there is motion in the area around the stand or table. In response, computer-readable instructions 221 executable by the one or more processors 215 may communicate commands, messages and/or signals to components or assemblies of the charging and protection stand or table 100 to alert that motion has been detected (e.g., commands, messages or signals may be communicated to one or more lighting systems 150 to emit a specific pattern or may be communicated to audio systems 225 and/or speakers 255 to audibly alert that motion has been detected. In response to detection of motion, computer-readable instructions 221 executable by the one or more processors 215 may communicate commands, messages and/or signals to an external computing device (e.g., such as a mobile computing device) to identify that motion has been detected around the mobile communication device charging and protection stand or table and to prompt a user of the mobile communication device to decide whether or not to take action. In some embodiments, the one or more sensor assemblies 260 may be directional sensors. In some embodiments, the directional sensors may be digital compasses, GPS transceivers, magnetometers, barometers, accelerometers and/or gyroscopes. In some embodiments, the directional sensors may capture direction measurements and/or other parameters related to the charging and protection table and/or stand 100. In some embodiments, computer-readable instructions 221 may be executable by one or more processors 215 of the stand or table 100 to receive the captured direction measurements and/or other parameters and to store the captured direction measurements and/or other parameters in one or more memory devices 220. In some embodiments, computer-readable instructions 221 may be executable by one or more processors 215 of the stand or table 100 to communicate the captured direction measurements and/or other parameters (of the directional sensors) to an external computing device such as a mobile communication device.

In some embodiments, the control housing 120, the speaker housing 125, the shelf assembly 130 and/or the table-top assembly may comprise one or more imaging devices 270. In some embodiments, the one or more imaging devices 270 may capture images and/or video from an area around the mobile communication device charging and protection stand or table 100. In some embodiments, computer-readable instructions 221 executable by the one or more processors 215 may store the captured or obtained video and/or images in one or more memory devices 220 from the one or more imaging devices 270 and/or may communicate the captured or obtained video and/or images to an external computing device (e.g., like a mobile communication device) via one or more wireless communication transceivers 235.

In some embodiments, the control housing 120, the speaker housing 125, the shelf assembly 130 and/or the table-top assembly 135 may comprise one or more microphones 275. In some embodiments, the one or more microphones 275 may capture sounds, audio and/or voice commands spoken by users or operators in an area around the charging and protection stand or table 100. In some embodiments, the sounds or audio may be stored in one or more memory devices 220 and/or communicated to an external computing device via one or more wireless communication transceivers 235. In some embodiments, computer-readable instructions 221 may be executable by one or more processors 215 to analyze the voice commands and determine what actions the charging and protection stand or table 100, as will be described in detail below.

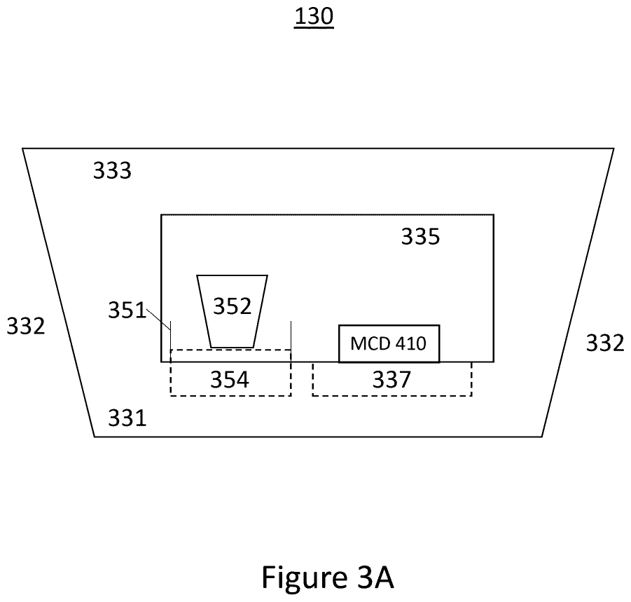

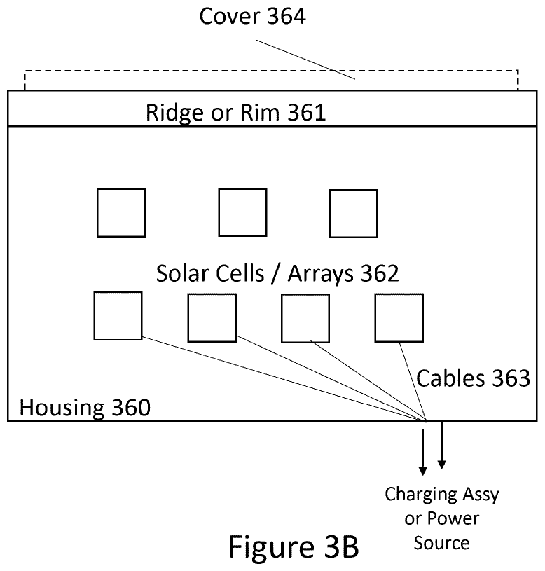

In some embodiments, the mobile communication device charging and protection stand 100 may comprise a shelf assembly 130. FIG. 3A illustrates a side view of a shelf assembly 130 according to some embodiments. In some embodiments, a shelf assembly 130 may comprise a bottom section or subassembly 331, two side sections or subassemblies 332 and/or a top section or subassembly 333. In some embodiments, the shelf assembly 130 may comprise a hollow area or opening 335 in between the bottom section or subassembly 331, two side sections or subassemblies 332, and the top section or subassembly 333. In some embodiments, the bottom section may have a surface (which may be referred to as a bottom surface) on which electronic devices (e.g., mobile communication devices) may rest. In some embodiments, these mobile communication devices may be cellular phones, smart phones, tablets, chargeable and/or wireless earphones or earbuds, or other similar devices. In some embodiments, the shelf assembly 130 may comprise charging circuity 337 (e.g., a power source coupled to cables or wires further coupled with induction coils) which may be referred to as induction charging assemblies. In some embodiments, the power source may generate voltage and/or current (e.g., power) which may be transferred to the induction coils in order to produce a magnetic field and allow a mobile communication device to powered by placing the mobile communication on top of the induction coils. In some embodiments, the charging circuity 337 may be embedded and/or integrated into a top surface of a bottom section or subassembly 331 of the shelf assembly. In some embodiments, the charging circuitry 337 may power and/or charge a mobile communication device placed on top of or near the charging circuitry 337. In some embodiments, the top section or subassembly 333 of the shelf assembly 130 may protect one or more mobile communication devices placed on the top surface of the bottom section or subassembly 331 from outside elements (e.g., sunlight, rain and/or other environmental conditions). In some embodiments, the top section or subassembly 333 may have the same dimensions (length and width) as the bottom section or subassembly 331 in order to provide maximum protection for any mobile communication devices placed on a top surface of the bottom section or subassembly 331 of the mobile communication device protection and charging table or stand 100. This is a significant advantage over any other charging tables in that prior art tables may allow mobile communication devices to be charged, but do not provide any protection from environmental elements. In some embodiments, other tables may also include an awning and/or an umbrella canopy or frame in order to provide protection from environmental conditions and/or elements. However, these are placed a distance away from the user and/or the phone and may not provide adequate protection from the elements. This mobile communication device charging and protection apparatus described herein provides charging and/or protection while also being outdoors. The protection allows mobile communication devices to be charged and not be subjected to overheating.

In some embodiments, the shelf assembly 130 may also comprise a drink or liquid holder assembly 350. In some embodiments, the drink or liquid holder assembly 350 may have circular or semi-circular raised portions 351 off the top surface of the bottom section or assembly 331 to allow a drink or cup to be placed on the top surface and not fall down. In some embodiments, the drink or liquid holder assembly 350 may be placed or positioned in a recessed or sunken area of a top surface of the bottom section or assembly 331. In some embodiments, the drink or liquid holder assembly 350 may also be able to cool or heat a liquid by the utilizing of a conductive cup 352 and/or a thermal device or circuitry 354. In some embodiments, the power source 227 may provide power to a thermal device or circuitry 354. In some embodiments, the power source may provide power to thermal device or circuitry 354 in order to heat up or cool down the liquid in the conductive cup 352. In some embodiments, the top section or subassembly 333 may protect any drinks positioned on placed on the bottom section or subassembly 332 from any outside elements, such as sunlight, rain and/or other environmental conditions. This is another advantage of this table over other prior table designs.

In some embodiments, the mobile communication device charging and protection stand or table 100 may comprise a table-top assembly 135. FIG. 3B illustrates a block diagram of a table-top assembly according to some embodiments. In some embodiments, a table-top assembly 135 may be placed on a top surface of a top section or subassembly 333 of the shelf assembly 130. In some embodiments, a table-top assembly may comprise an oval, circular or square shaped housing 360 with a rim 361 running around a circumference of the oval, circular or square shaped housing 360, one or more solar cells, cell arrays or panels 362 and/or wires or cables 363. In some embodiments, the wires or cables 363 may couple the one or more solar cells, cell arrays or panels 362 to the charging assembly and/or power source of the mobile communication device charging and protection stand or table 100. In some embodiments, in order to protect the one or more solar cells, cell arrays or panels 362 from the element, the table-top assembly 135 may comprise a top cover 364 to cover the one or more solar cells, cell arrays or panels 362. In some embodiments, in order to allow to one or more solar cells, cell arrays or panels 362 to convert sun energy to the electric power, the top cover 364 of the table-top assembly 135 may be transparent and/or see through plastic or a similar transparent material. In other cases, the top cover may be more opaque in order to block out the sun from the one or more solar cells, or solar cell arrays and keep them from overheating. In some embodiments, the table-top assembly 135 may be made of a plastic material, a metal material, a wood material, a composite material and/or any combination thereof. In some embodiments, the table-top assembly 135 may further comprise one or more sensor assemblies 260 (e.g., environmental sensors, directional sensors, and/or proximity sensors) as described above. In some embodiments, the table-top assembly 135 may further comprise one or more microphones 275, the one or more microphones utilized to capture voice commands by users and/or operators of the mobile communication device charging and protection stand or table 100. The operation of the one or more microphones is described above. In some embodiments, the table-top assembly 135 may further comprise one or more imaging devices 265, the operation of which i described above. In some embodiments, the table-top assembly 135 may not include a ridge or rim. In some embodiments, the table-top assembly 135 may comprise a recessed area in its center where the one or more solar cells or solar cells arrays 362 may be located and/or positioned.

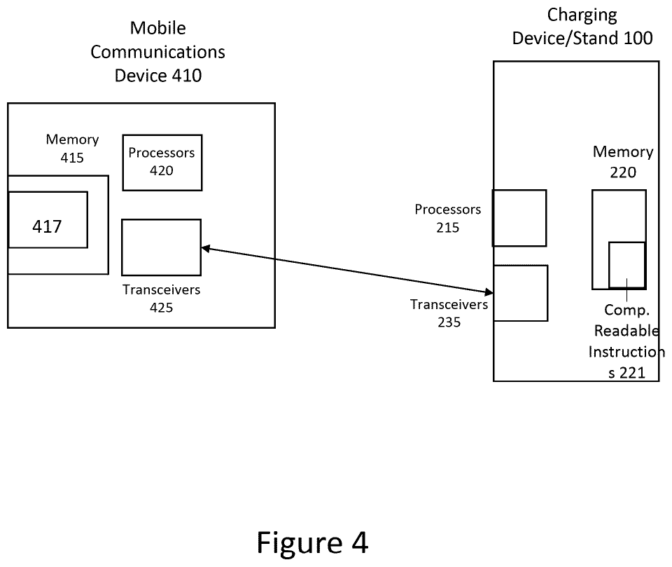

FIG. 4 illustrates a mobile communication device configured to engage in bidirectional communications with a charging and protection stand according to some embodiments. In some embodiments, a mobile communication or computing device 410 may communicate with the charging and protection stand 100 in order to control operations of components, assemblies and/or devices (e.g., lighting assemblies, wireless communication transceivers, speakers and/or audio receivers, solar cells or solar cell assemblies and charging assemblies), receive status parameters for components, assemblies and/or devices, and/or receive sensor measurements or parameters. In embodiments, a mobile communication device 410 may be communicating bi-directionally with the charging and protection stand 100. This is a significant improvement over communicating via a remote control device where only limited commands such as on or off may be communicated to tables and there is no receiving of parameters and/or measurements back from a table. The charging and protection stand or table 100 described herein may be controlled by a software application running on a mobile computing device 410 and may communicate measurements, parameters, information and/or audio back to the mobile communications device 410. In some embodiments, for example, a mobile communication device 410 may comprise one or more processors 420, one or more memory devices 415, one or more wireless communication transceivers 425 and/or computer-readable instructions 417 stored in the one or more memory devices 415. In some embodiments, the computer-readable instructions 417 stored in the one or more memory devices 415 may include charging and protection stand software (e.g., interface or control software for communicating and receiving communications from the charging and protection stand or assembly or table 100). In some embodiments, the computer-readable instructions 417 may be executable by the one or more processors 420 to communicate and/or interface with the charging and protection stand or assembly 100 In some embodiments, for example, the software 417 executable by one or more processors 420 of a mobile computing device 410) may communicate commands, messages and/or instructions to a charging and protection stand or assembly 100 via one or more wireless communication transceivers 425 to turn on and off the charging and protection stand or assembly or table, to turn on lighting assemblies, to engage and/or activate solar cells and/or solar arrays and/or charging assemblies, to turn on charging and protection stand wireless communication transceivers, to transfer audio files, to turn on or off or put into a power-saving move a power source, to engage and/or activate selection assemblies and/or buttons, to turn on or off sensor assemblies, to communicate with induction charging systems and/or to communicate and/or activate audio receivers and/or speakers, as well as other features describe herein.

In some embodiments, the communications may be received via one or more wireless communication transceivers 235 in the charging and protection stand or assembly 100. In embodiments, the software 417 (e.g., computer-readable instructions) in the mobile computing device 410 may receive operational parameters and/or confirmation back that the operation has been completed and the utilized components, devices, and/or assemblies (e.g., lighting assemblies or sensor assemblies) are operational via the one or more wireless communications transceivers 425 in the mobile computing device 410. In some embodiments, as another example, a mobile communication device 410 may communicate a command to activate a temperature sensor (or other sensor in the charging and protection stand or assembly 100) and to capture temperature sensors (or other sensor) readings or measurements. In some embodiments, charging and protection stand or assembly or table 100 may communicate and/or transmit back captured temperature sensor measurements (or other sensor measurements) to the mobile communication device 410 utilizing the one or more wireless communication transceivers 235 in the automation attachment and the one or more wireless communication transceivers 425 in the mobile computing device 410. In some embodiments, the components or assemblies of the charging and protection stand or assembly 100 that may be bidirectionally communicated with by the mobile computing device 272 may include one or more environmental sensors, one or more directional sensors, one or more imaging devices, one or more audio receivers and/or speakers, one or more voice recognition engines, one or more lighting elements or lighting assemblies, one or more microphones, one or more battery assemblies, one or more charging assemblies, one or more wireless communication transceivers and/or one or more solar panels or solar cells. In some embodiments, a mobile communication or computing device 410 may utilize software installed thereon to communicate with the charging and protection stand or assembly 100 (e.g., SMARTSHADE SOFTWARE) and receive input via a touchscreen, a keyboard, a stylus or other user interface input components. In some embodiments, a user or operator may speak audio commands into a mobile computing device 410 to control operation of the charging and protection stand or assembly 100 (“Turn on Cellular Wireless Transceivers, Turn on Solar Cell Assemblies, Turn on Speakers or Audio System, Turn on or off lights, Capture Sensor Measurements”). These are representative commands and other voice commands may be utilized to interact, control and/or interface with the charging and protection stand or assembly 100.

In some embodiments, the computer-readable instructions 417 executable by the one or more processors 420 of the mobile computing device 410 may include voice recognition software in addition to the protection and charging device/stand/assembly software. In some embodiments, the voice recognition software executing on the one or more processors 420 of the mobile computing device 410 may recognize, interpret and generate protection and charging table/stand-specific commands and the mobile computing device 410 may communicate the generated protection and charging table/stand-specific commands to the protection and charging table/stand via wireless communication transceiver 425 and wireless communication transceiver 235 (e.g., in the charging and protection stand or assembly or table) to control operations of assemblies and/or components in the protection and charging device/stand 100 (e.g., audio systems, solar panels and charging assemblies, sensors, lights, etc.). In some embodiments, the voice commands may be communicated as audio files to the protection and charging device/stand/table 210, (via the wireless communication transceivers 425 and 235) and computer-readable instructions executable by one or more processors 215 in the protection and charging device/stand 100, which may either analyze, recognize and then generate protection and charging table/stand-specific commands locally (e.g., within the charging and protection stand or assembly or table 100) or may communicate the received audio files (or text representative thereof) to a third party computing device (a voice recognition server, such as Alexa servers, located locally or remotely) for analyzation, interpretation and generation of protection and charging table/stand-specific commands, which are then communicated back to the charging and protection stand or assembly or table 100 in order to have the recognized operations performed via one or more wireless or wired communication transceivers 235.

In some embodiments, the mobile communications device 410 may be a smartphone, a tablet, a laptop computer, a network computer, a mobile phone, etc.). Although the discussions above have focused on a mobile computing device, the discussions apply to desktop computers, administrative computing devices, point-of-sale computing devices and/or home security computing devices, all of which can have charging and protection stand or assembly interface software installed thereon and executable by processors to interface with and/or control an charging and protection stand or assembly 100 that the desktop computing device, administration computing device, POS computing device and/or home security device are communicatively coupled with (e.g., via wireless or wired communication transceivers).

In some embodiments, a mobile communications device 410, a computing device at a remote location, or an existing computing device (e.g., a POS terminal at a hospitality venue) may communicate with and receive communications from a plurality of charging and protection stand or assemblies 100 utilizing wireless or wired communication transceivers. In some embodiments, for example, this means a facility or event venue may have multiple charging and protection stand or assemblies and be able to control the operation of multiple charging and protection stand or assembly 100. This provides an advantage and/or improvement over existing systems because there is the ability to automate a number of charging and protection stands or assemblies or tables 100 In some embodiments, the mobile computing device 410 (or computing device at a remote location or existing computing device at hospitality venue) may bidirectionally communicate with two or more charging and protection stand or assemblies 100 via the one or more wireless communication transceivers 235 in a single charging and protection stand or assembly 100 or via the one or more wireless communication transceivers 235 in both charging and protection stand and/or assemblies or tables. In some embodiments, the components, assemblies or devices (e.g., environmental sensor assemblies; audio systems and speakers, solar cells or panels and/or charging assemblies, and/or lighting assemblies, and/or one or more image devices) may communicate sensor measurements and values; audio, video, images; and/or status parameters of components, assemblies or devices back to the mobile computing device 410 via the one or more wireless computing devices (or computing device at a remote location or existing computing device at hospitality venue). In some embodiments, the measurements and/or status parameters (e.g., and/or audio, video or images) may be displayed within application software executing on the mobile computing device 410 (or remote computing devices describe above) after being received via the one or more wireless communication transceivers (e.g., such as the wireless communication transceiver(s) 425 of the mobile computing device 410). In embodiments, the operation of the multiple charging and protection stand or assemblies 100 may be controlled via fleet management software such as has been described in application Ser. No. 16/008,000, filed Jun. 13, 2018, and entitled METHOD AND SYSTEM OF FLEET MANAGEMENT OF SHADING DEVICES, which is incorporated herein by reference. In embodiments, voice control, gesture recognition and/or utilization of menu icons may be utilized to control operation of one or more multiple charging and protection stand or assemblies 100 through the application software described herein.

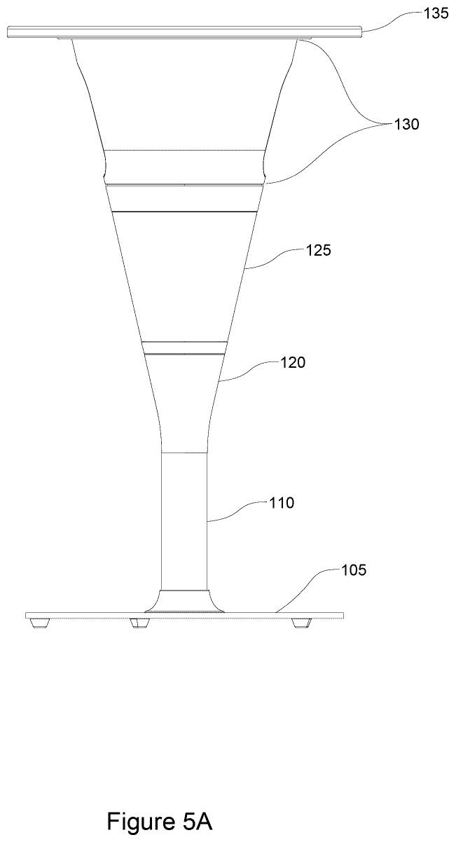

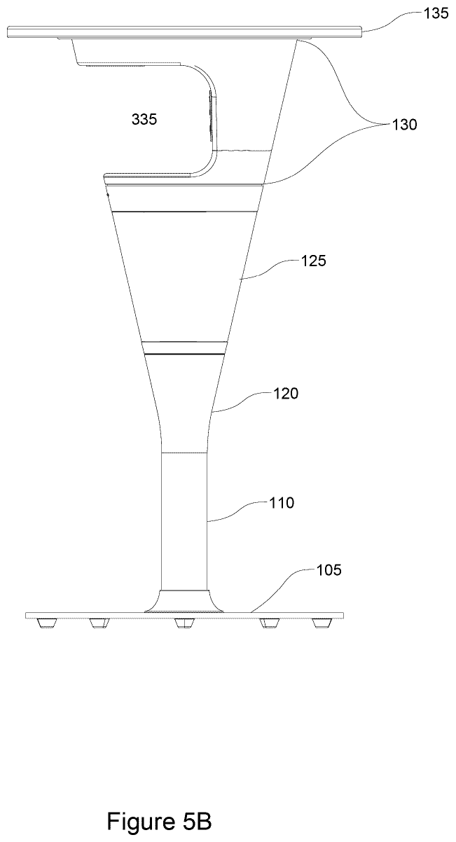

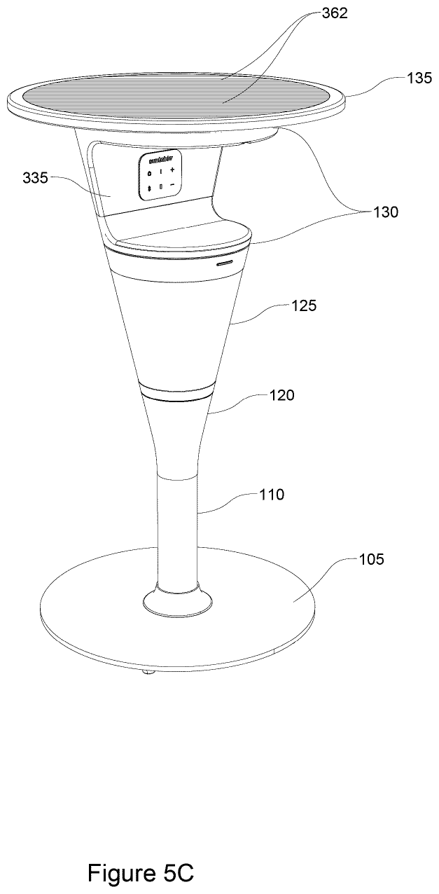

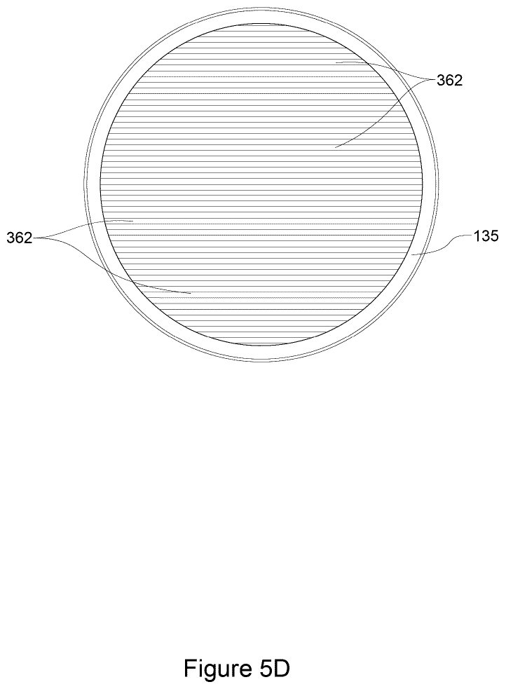

FIG. 5A illustrates a side view of a mobile communication device charging and protection stand or table according to some embodiments. FIG. 5B illustrates a front view of the mobile communication device charging and protection stand or table according to some embodiments. FIG. 5C illustrates a perspective top view of the mobile communication device charging and protection stand or table according to some embodiments. FIG. 5D illustrates a top view of the mobile communication device charging and protection stand or table according to some embodiments. These figures show a prototype model of a mobile communication device charging or protection table or stand according to embodiments. In some embodiments, the mobile communication device charging and protection table or stand may include a base assembly 105, a central support assembly 110, a control housing or assembly 120, a speaker housing 125, a shelf assembly 130 and/or a table-top assembly 135. In some embodiments, the central support assembly 110 may also include the control housing or assembly 120. In some embodiments, the central support assembly may be connected and/or coupled to the base assembly 105 and/or the speaker housing 125. In some embodiments, if the central support assembly 110 and the control housing or assembly 120 are separate assemblies, and therefore the control housing or assembly 120 may be connected and/or coupled to the central support assembly 110 and/or the speaker housing 125. In some embodiments, the speaker housing 125 may be coupled and/or connected to the shelf assembly 130. In some embodiments, the table-top assembly 135 may be connected and/or coupled to the shelf assembly 130.

In some embodiments, the components and/or assemblies shown in FIGS. 2, 3A or 3B (and discussed above) may also be included in the mobile communication device charging and protection stand or table. FIGS. 5C and 5D illustrate the one or more solar cells or cell arrays 362 according to some embodiments. In some embodiments, as shown in FIG. 5D, the one or more solar cells or cell arrays 362 may be in a center portion of the table-top assembly 135. In some embodiments, as shown in FIG. 5D the one or more solar cells or cell arrays 362 may be arranged in a circular pattern. In some embodiments, a table-top assembly 135 may have a recessed portion into which the one or more solar cells or cell arrays 362 are placed, attached and/or connected. FIG. 5B clearly illustrates the opening and/or hollow portion 335 of the shelf assembly 130 according to some embodiments. This is a significant feature of the mobile communication device charging and protection stand or table 500. This is where the charging of the mobile communication device may occur while at the same time providing shade to the mobile communication device. Other tables either do not provide shade or provide shade via a umbrella canopy or shading apparatus.

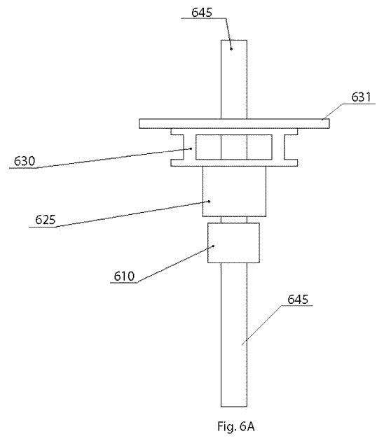

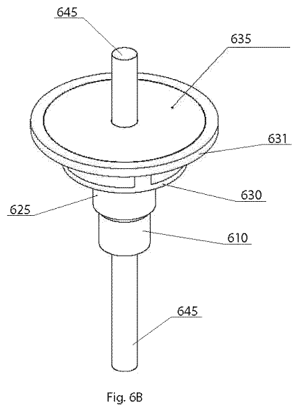

FIG. 6A illustrates a side view of a sun table power apparatus according to some embodiments. In some embodiments, the sun table apparatus or device may comprise a table-top assembly 631, a shelf assembly 630, one or more speaker assemblies 625 and/or a locking assembly 610. In some embodiments, the locking assembly 610 may tighten around an existing parasol pole 645 in order to hold the sun table power apparatus in place. In some embodiments, the speaker assembly may be located in a higher vertical position than the locking assembly 610. In some embodiments, the speaker assembly 625 may be connected to a top surface of the locking assembly 610. In some embodiments, the shelf assembly 630 may comprise an opening where a mobile communication device may be placed in order to charge. When the mobile communication device is placed in the opening of the shelf assembly 630, it is also protected from the sun and/or other environmental conditions. FIG. 6B illustrates a top perspective view of a sun table charging apparatus or device according to some embodiments. FIG. 6B illustrates the components or portions of the sun table apparatus illustrated in FIG. 6A. FIG. 6B also shows a top surface 635 of the sub table power apparatus, and the top surface 635 may include one or more solar cells or solar cell arrays. In some embodiments, the top surface 635 and the table top assembly 631 may be circular and/or oval in shape.

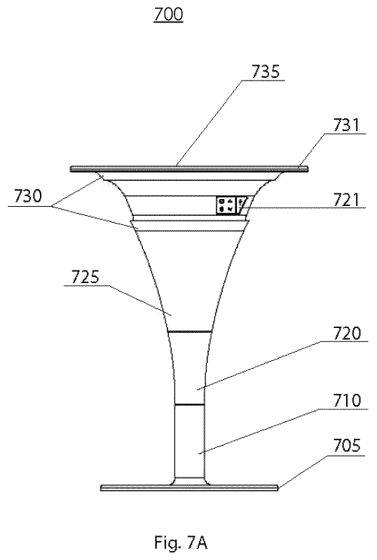

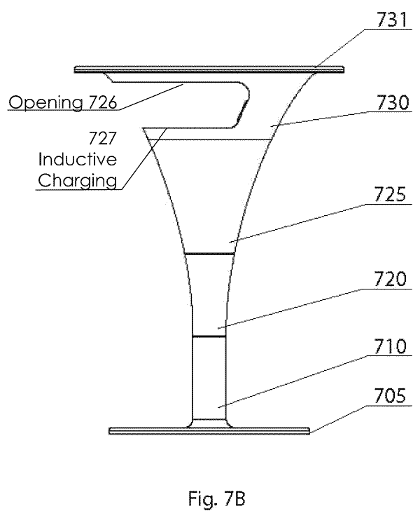

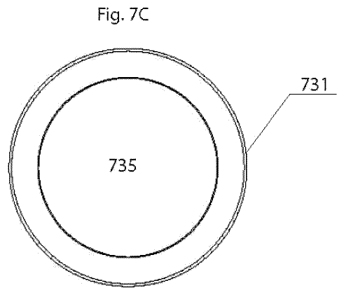

FIG. 7A illustrates a side view of a free-standing sun table power charging apparatus including a one-sided shelf assembly according to some embodiments. FIG. 7B illustrates a front view of a free-standing sun table power charging apparatus including a one-sided shelf assembly according to some embodiments. FIG. 7C illustrates a top view of a free-standing sun table power charging apparatus including a one-sided shelf assembly according to some embodiments. In some embodiments, the opening allows a user or operator to easily slide in a mobile communication device for charging or powering on the shelf assembly. In some embodiments, the free-standing, sun table charging device includes a top surface 735 which includes one or more solar cells or arrays (not shown), a table top or top assembly 731, a one-sided shelf assembly 730, a speaker assembly 725, an upper center support assembly 720, a lower center support assembly 710 and/or a base assembly or base plate 705. In some embodiments, the one-sided shelf assembly may comprise control buttons or panels 721 to allow operation of the free-standing sun table. In some embodiments, one or more induction charging assemblies or plates 727 will be on a top surface of the opening of the shelf assembly 730. In some embodiments, because the shelf assembly 730 is one-sided, a user can easily place the mobile communication device in the opening 726 and onto one of the one or more induction charging assemblies or plates 727. In some embodiments, the lower center support assembly 710 is attached or coupled to the base plate 705 and the upper center support assembly 720 is attached or coupled to the lower center support assembly 710. In some embodiments, the speaker assembly 725 may be connected or coupled to the upper center support assembly 720. In some embodiments, the shelf assembly 730 may be coupled to the speaker assembly 725. In some embodiments, a table-top or table assembly 731 may be connected, attached or coupled to the shelf assembly 730. In some embodiments, the electronic or mechanical components described above may be located in the shelf assembly 730, the speaker assembly 725, the upper center support assembly 720 and/or the lower center support assembly 710. In some embodiments, the sun table 700 is free-standing and thus can be utilized on any level surface including, but not limited to, cement, asphalt, grass and/or dirt.

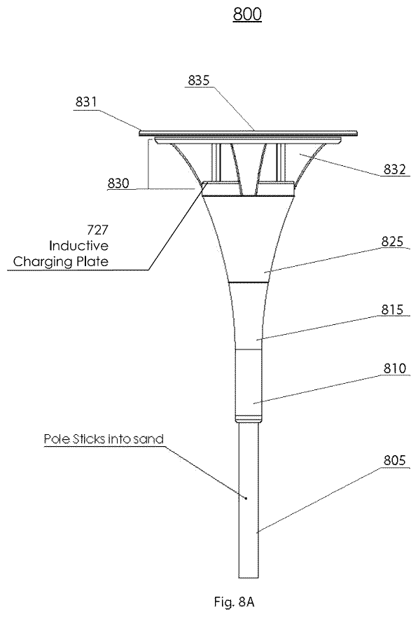

FIG. 8A illustrates a front view of a sun table charging apparatus to be utilized in loose ground environments such as sand according to some embodiments. FIG. 8B illustrates a side view of a sun table charging apparatus to be utilized in loose ground environments such as sand according to some embodiments. In some embodiments, the sun table charging apparatus 800 includes a top surface 835, a table top or table assembly 831, a plurality of vertical connectors 832 which are part of a shelf assembly 830, one or more speaker assemblies 825, an upper center support assembly 815, a lower center support assembly 805 and/or a pole or shaft 805 that may be inserted into the loose ground (e.g., the sand) in order to allow the sun table charging apparatus to be utilized in an outdoor environment such as the beach. In some embodiments, the pole or shaft 805 may be made of plastic, fiberglass and/or a metal material. In some embodiments, the pole or shaft 805 may be connected to lower center support assembly 810 and the lower center support assembly 810 may be connected or attached to the upper center support assembly 815. In some embodiments, a diameter of the pole or shaft 805 may be smaller than a diameter of the lower center support assembly 810 or the upper center support assembly 815. In some embodiments, the speaker assembly 825 may be connected, coupled or attached to the upper center support assembly 815 and the speaker assembly may be connected, couple or attached to the shelf assembly 830. In some embodiments, the plurality of vertical connectors 832 may be coupled the speaker assembly 825 or a bottom portion of the shelf assembly to the top portion of the shelf assembly 830. In some embodiments, the plurality of vertical connectors 832 leave openings so that a user or operator may place a mobile communication device onto a bottom portion of the shelf assembly 830. In some embodiments, a top surface of a bottom portion of the shelf assembly 830 may have inductive charging assemblies or plates that may power up the mobile communication device. In some embodiment, the shelf assembly 830 may be coupled to a table assembly or tabletop 831, which has a top surface 835 (where the top surface includes one or more solar cells or arrays).

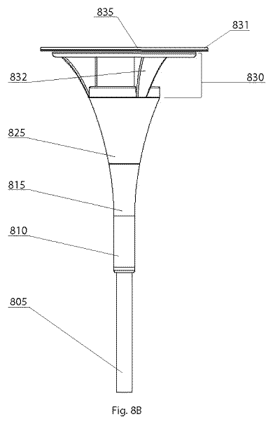

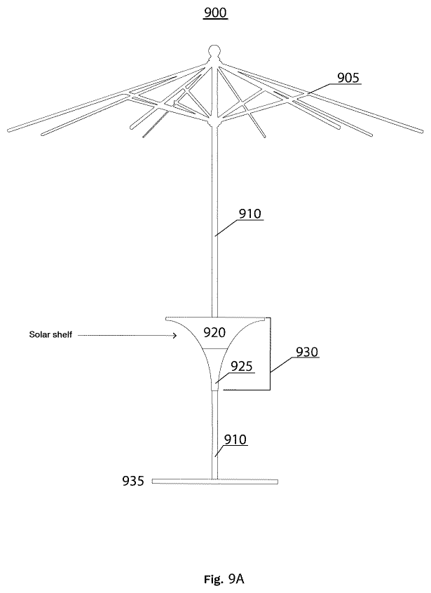

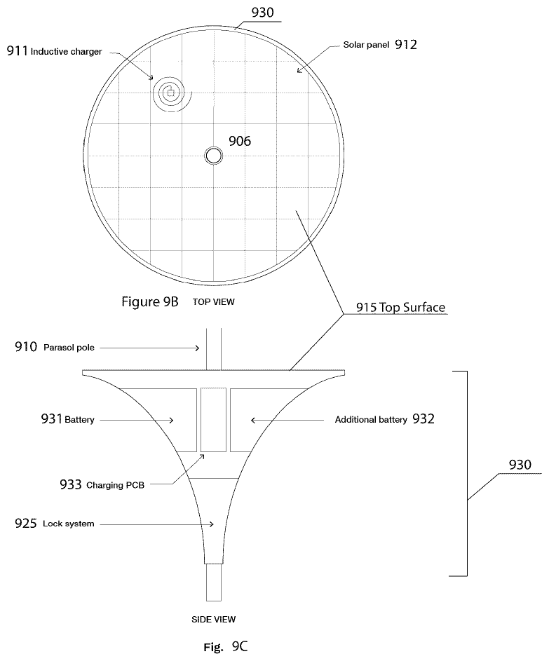

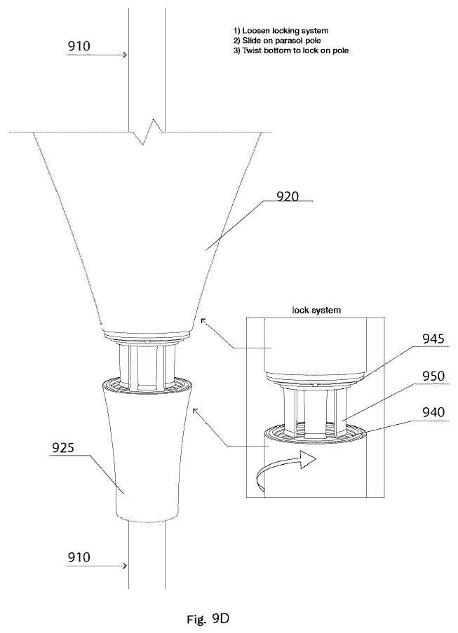

FIG. 9A illustrates a parasol with an attachable or connectable solar shelf according to some embodiments. In some embodiments, a parasol or umbrella with a solar shelf 900 may include a frame (or arms) 905, a central support pole or assembly 910, a base assembly 935 and a connectable or attachable solar shelf 930. In some embodiments, the connectable or attachable solar shelf 930 may include a top portion 920 and a bottom portion 925. In some embodiments, the connectable solar shelf 930 may be attached to the central support pole or assembly 910 and may be connectable to existing parasol poles.

FIG. 9B illustrates a top view of a solar shelf or sun table according to some embodiments. In some embodiments, a top surface of a solar shelf 930 may comprise one or more inductive chargers 911 (e.g., one or more inductive charging plates), one or more solar cells or solar cell arrays 912, and an opening or hole 906 in the top surface of the solar shelf 930. In some embodiments, a user or operator may place a mobile computing or communication device or other electronic devices (which have inductive charging capability or functionality) on the inductive charger 911 in order to power the mobile computing or communication device or other electronic device. In some embodiments, there may be multiple inductive chargers or charging assemblies 911 on a top surface of the solar shelf or sun table 930.

FIG. 9C illustrates a cut away side view of the attachable or connectable solar shelf according to some embodiments. In some embodiments, the solar shelf 930 may be attached or connected to a parasol pole 910 at a bottom portion of the solar shelf 930. In some embodiments, the solar shelf 930 may comprise a top surface 915 of a solar shelf, one or more renewable power sources 931 and 932 (e.g., rechargeable batteries), a charging assembly or printed circuit board 933, and/or a locking system 925. In embodiments the one or more solar cells or solar panels 912 may gather or capture light from the sun, generate power which is then transferred to the charging assembly or charging PCB 933. In some embodiments, the charging assembly 933 may transfer power to the one or more renewable power sources 931 and 932. In some embodiments, the one or more renewable power sources 931 and 932 (e.g., renewable batteries) may provide power to the one or more inductive chargers 911 at the top surface 915 of the solar shelf. In embodiments, the charging assembly 933 may provide power directly to the one or more inductive chargers or inductive charging assembly 911 at the top surface 915 of the solar shelf.

FIG. 9D illustrates a side view of a top section and a bottom section of the attachable or connectable solar shelf according to embodiments. In some embodiments, a top section 920 of the solar shelf may be attached to a bottom section 925 of the solar shelf and the bottom section 925 of the solar shelf may be connected or attached to the parasol pole 910. In embodiments, a lock system may comprise one or more tapered ridges 945 on an inner bottom portion of the top section 920 and one or more recessed channels 940 on an inner top portion of the bottom section 925. In some embodiments, the bottom section 925 of the solar shelf may be twisted or rotated to that the tapered ridges 945 fit into the recessed channels 940 for a tight seal or tight connection. In embodiments the locking system may also include one or more vertical plates or vertical connectors 950 (e.g., there are three vertical plates illustrated in FIG. 9D), that press against the parasol pole 910 to connect or attach the solar shelf to the parasol pole. In embodiments, the one or more vertical plates or vertical connectors 950 may have ridges or notches or a material (e.g., rubber or foam) that may be pressed against the parasol pole 910 when the locking system is engaged (e.g. the bottom section 925 of the solar shelf is twisted and/or locked to the top section 920 of the solar shelf as well as attached or connected to the parasol pole.

In exemplary embodiments, a solar-powered table and charging assembly includes a base unit; and a top section detachably coupled or connected to the base unit, the top section including: one or more solar cell assemblies including one or more solar cells, the one or more solar cells to receive light from a solar light source and convert the light to electrical energy; one or more battery charge controllers coupled to the one or more solar cell assemblies and one or more rechargeable batteries to receive the electrical energy and to transfer the electrical energy to charge the one or more rechargeable batteries; and one or more processors or controllers, one or more memory devices and computer-readable instructions stored in the one or more memory devices and executable by the one or more processors or controllers to control operation of the solar-powered table, wherein the one or more rechargeable batteries or the one or more battery charge controllers provide electrical power to the one or more processors or controllers and the one or more memory devices. In exemplary embodiments, the solar-power table and charging assembly includes one or more wireless communication transceivers, one or more media players, and one or more speaker assemblies, the one or more wireless communication transceivers configured to receive music media files from an external computing device and to transfer the received music media files to the one or more media players, the one or more media players configured to transfer the received music media files to the one or more speaker assemblies to reproduce audio from the received music media files. In exemplary embodiments, the solar-power table and charging assembly includes a control panel, the control panel configured to display operations of the solar-powered table. In exemplary embodiments, the top section of the solar powered table and charging assembly includes an acrylic top, the one or more solar cell assemblies placed under the acrylic top. In exemplary embodiments, the base unit of the solar powered table and charging assembly receives the electrical power from the one or more rechargeable batteries or the one or more battery charge controllers and the base unit further comprises one or more motor controllers, one or more motor assemblies, one or more shaft assemblies, and one or more base gear or cam assemblies, one or more base processors or controllers, one or more base memory devices and/or computer-readable instructions stored in the one or more base memory devices and executable by the one or more base processors or controllers to control operations of the one or more motor assemblies through the one or more motor controllers. In exemplary embodiments, the top section of the solar-powered table and charging assembly further comprises one or more coupling assemblies and/or one or more gear assemblies, the one or more motor controllers to receive commands from the one or more base processors or controllers to activate the one or more motor assemblies, which in turn activates the one or more motor shaft assemblies, which in turn engages the one or more base gear or cam assemblies which in turn engages the one or more gear assemblies to turn the one or more top section of the solar-powered table or charging assembly.

As detailed above, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step. In addition, one or more of the devices described herein may transform data, physical devices, and/or representations of physical devices from one form to another. For example, one or more of the devices recited herein may receive image data of a sample to be transformed, transform the image data, output a result of the transformation to determine a 3D process, use the result of the transformation to perform the 3D process, and store the result of the transformation to produce an output image of the sample. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of. ” Finally, for ease of use, the terms “including” and “having” (and their derivatives), as used in the specification and claims, are interchangeable with and shall have the same meaning as the word “comprising.

The processor as disclosed herein can be configured with instructions to perform any one or more steps of any method as disclosed herein.

As used herein, the term “or” is used inclusively to refer items in the alternative and in combination.

As used herein, characters such as numerals refer to like elements.

Embodiments of the present disclosure have been shown and described as set forth herein and are provided by way of example only. One of ordinary skill in the art will recognize numerous adaptations, changes, variations and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

1. A solar-powered table and charging assembly, comprising:
a base unit; and
a top section detachably coupled or connected to the base unit, the top section including:
one or more solar cell assemblies including one or more solar cells, the one or more solar cells to receive light from a solar light source and convert the light to electrical energy;
one or more battery charge controllers coupled to the one or more solar cell assemblies and one or more rechargeable batteries to receive the electrical energy and to transfer the electrical energy to charge the one or more rechargeable batteries; and
one or more processors or controllers, one or more memory devices and computer-readable instructions stored in the one or more memory devices and executable by the one or more processors or controllers to control operation of the solar-powered table, wherein the one or more rechargeable batteries or the one or more battery charge controllers provide electrical power to the one or more processors or controllers and the one or more memory devices.

2. The solar-powered table of claim 1, further comprising one or more wireless communication transceivers, one or more media players, and one or more speaker assemblies, the one or more wireless communication transceivers configured to receive music media files from an external computing device and to transfer the received music media files to the one or more media players, the one or more media players configured to transfer the received music media files to the one or more speaker assemblies to reproduce audio from the received music media files.

3. The solar-powered table of claim 2, further comprising a control panel, the control panel configured to display operations of the solar-powered table.

4. The solar-powered table of claim 1, wherein the top section includes an acrylic top, the one or more solar cell assemblies placed under the acrylic top.

5. The solar-powered table of claim 1, wherein the base unit receives the electrical power from the one or more rechargeable batteries or the one or more battery charge controllers and the base unit further comprises one or more motor controllers, one or more motor assemblies, one or more shaft assemblies, and one or more base gear or cam assemblies, one or more base processors or controllers, one or more base memory devices and/or computer-readable instructions stored in the one or more base memory devices and executable by the one or more base processors or controllers to control operations of the one or more motor assemblies through the one or more motor controllers.

6. The solar-powered table of claim 5, wherein the top section further comprises one or more coupling assemblies and/or one or more gear assemblies, the one or more motor controllers to receive commands from the one or more base processors or controllers to activate the one or more motor assemblies, which in turn activates the one or more motor shaft assemblies, which in turn engages the one or more base gear or cam assemblies which in turn engages the one or more gear assemblies to turn the one or more top section of the solar-powered table.

7. A portable solar-powered speaker assembly comprising:
a main body; and
a base unit,
wherein the main body is configured to be detachable and thus separatable from the base unit;
the main body includes: a shelf assembly, a vertical connection assembly, a horizontal resting area, and one or more speaker assemblies,
wherein the horizontal resting area includes an inductive charging assembly,
wherein the vertical connection assembly includes a control panel with one or more selection buttons or icons,
wherein the vertical connection assembly connects or couples the shelf assembly to the horizontal resting area, and
wherein the horizontal resting area is connected or coupled to the one or more speakers and the one or more speakers reside below the horizontal resting area.
